(19) United States
(12) Patent Application Publication
(10) Pub. No.: US 2025/0358061 A1
(43) Pub. Date: Nov. 20, 2025

(54) METHODS FOR TRANSMITTING DOWNLINK OTFDM SYMBOL AND TRANSMITTERS THEREOF

(71) Applicant: WISIG NETWORKS PRIVATE LIMITED, Madinaguda, Hyderabad (IN)

(72) Inventors: SaiDhiraj Amuru, Manikonda, Hyderabad (IN); Koteswara Rao Gudimitla, Srikalahasti, Andhra Pradesh (IN); Sibgath Ali Khan Makandar, Sangareddy, Telangana (IN); Sakshama Ghoslya, Jaipur, Rajasthan (IN); Kiran Kumar Kuchi, Madinaguda, Hyderabad (IN); Smriti Kumari, Jamalpur, Munger, Bihar (IN)

(21) Appl. No.: 18/868,994

(22) PCT Filed: Jun. 3, 2023
(86) PCT No.: PCT/IN2023/050523

§ 371 Date: Nov. 25, 2024

(30) Foreign Application Priority Data
Jun. 3, 2022 (IN) 202241032000

(51) Int. Cl. H04L 5/00; H04L 27/26; H04W 72/30

(52) U.S. Cl. CPC H04L 5/0007; H04L 27/2678; H04W 72/30

(57) ABSTRACT

Embodiments of the present disclosure relate methods and systems for transmitting downlink Orthogonal time frequency-division multiplexing (OTFDM) symbol. The method comprising time-multiplexing, by the transmitter, at least one of a primary synchronization signal (PSS) sequence, a secondary synchronization signal (SSS) sequence and a physical broadcast channel (PBCH) sequence to generate a multiplexed sequence. Also the method comprises processing, by the transmitter, the multiplexed sequence to generate a SS Block OTFDM symbol.

### CROSS-REFERENCE TO RELATED APPLICATIONS

This application claims priority from the Indian Provisional Patent Application No. 20/224,1032000, filed on 3 Jun. 2022, the entirety of which are hereby incorporated by reference.

### TECHNICAL FIELD

Embodiments of the present disclosure are related, in general to communication, but exclusively relate to methods and systems for generating and transmitting OTFDM symbol.

### BACKGROUND

3GPP (3rd Generation Partnership Project) has developed 5G-NR standards to support use cases like eMBB, URLLC, MMTC. To support multiple access OFDMA has been agreed to use in current 5G-NR. However, in previous standards different Multiple access techniques have been studied and used, like in 2G TDMA, 3G is based on CDMA and relied on OFDMA. OFDM, in spite of many of its attractive properties, has a critical drawback i.e., low power-amplifier efficiency (low energy efficiency).

The communications latency is fundamentally limited by the delay before a transfer of data begins following an instruction for its transfer. This delay is equal to the duration of a “slot” which is a basic unit of information transmission that comprises of data/control and reference signals. A slot in OFDM systems comprises of multiple data symbols and one or more reference symbols. 4G uses 0.5 ms slot and 5G NR specifications allow URLLC using 0.125 ms. In order to achieve low latency 5G NR uses mini slots where the duration of the slot is two OFDM symbols. To achieve Extremely Low Latency Communication (ELLC) it is preferable to use a single OFDM symbol to transmit the information. Basic OFDM allows frequency multiplexing of reference signal and data/control within one OFDM symbol. Our chief aim is to use high energy efficiency waveform such as DFT-S-OFDM (it is a variant of OFDM with low-PAPR and is used in both 4G and 5G); this waveform requires a dedicated OFDM symbol for the transmission of RS and an additional symbol for data, thus resulting in two symbols duration (In conventional DFT-S-OFDM, RS is not time multiplexed with data in one OFDM symbol since this multiplexed RS does not offer reliable estimation of the channel impulse response). The RS is required for the purpose of estimating the channel state information (CSI) and subsequent equalization of data symbol. This two-symbol structure not only doubles the latency (compared to single symbol case), but also has a higher RS overhead i.e., 50%. There is a need for a new type of waveform that allows one shot transmission with flexible RS overhead and high-power efficiency. 6G Mobile Communication System requires a method of information transmission and that offers extremely low latency, very high data rate, and very high-power efficiency.

There is a need for a waveform technology that not only addresses this critical issue of improving energy efficiency but also achieves extremely low latency. Current 5G standards uses slot structure, where user data is transmitted in series of OFDM symbols. A typical slot structure comprises of one or more data symbols and one or more reference symbols.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting synchronization signal (SS) Block Orthogonal time frequency-division multiplexing (OTFDM) symbol is disclosed. The method comprising time-multiplexing, by the transmitter, at least one of a primary synchronization signal (PSS) sequence, a secondary synchronization signal (SSS) sequence and a physical broadcast channel (PBCH) sequence to generate a multiplexed sequence. Also the method comprises processing, by the transmitter, the multiplexed sequence to generate a SS Block OTFDM symbol.

In another aspect of the present disclosure a method for transmitting SS block is provided. The method comprising time-multiplexing, by the transmitter, a PSS OTFDM symbol, a SSS OTFDM symbol and a PBCH OTFDM symbol to generate a multiplexed sequence. Also, the method comprising processing, by the transmitter, the at least one multiplexed sequence to generate a SS Block.

In yet another aspect of the present disclosure a method for transmitting OTFDM SS burst is provided. The method comprising time-multiplexing, by the transmitter, a plurality of OTFDM SS Blocks to generate multiplexed OTFDM SS blocks, wherein each of the plurality of OTFDM SS Blocks is associated with a different beam.

In yet another aspect of the present disclosure a method for transmitting OTFDM SS burst is provided. The method comprising time-multiplexing, by the transmitter, a plurality of pre-DFT SS Blocks and guard blocks to generate a time multiplexed block, wherein each of the plurality of pre-DFT SS Blocks comprises a PSS, a SSS and a PBCH, said each of the plurality of pre-DFT SS block is associated with a beam. Also, the method comprises processing, by the transmitter, the multiplexed block using OTFDM generation unit to generate OTFDM SS burst.

In yet another aspect of the present disclosure a method for transmitting a PDCCH-PDSCH Orthogonal time frequency-division multiplexing (OTFDM) symbol is provided. The method comprising time-multiplexing, by the transmitter, a physical downlink control channel (PDCCH) sequence, a physical downlink shared channel (PDSCH) sequence and a reference sequence (RS) to generate a multiplexed sequence; and processing, by the transmitter, the multiplexed sequence to generate a PDCCH-PDSCH OTFDM symbol.

In yet another aspect of the present disclosure a method for transmitting a PDSCH Orthogonal time frequency-division multiplexing (OTFDM) symbol is provided. The method comprising time-multiplexing, by the transmitter, a physical downlink shared channel (PDSCH) sequence and a reference sequence (RS) to generate a multiplexed sequence and processing, by the transmitter, the multiplexed sequence to generate a PDSCH OTFDM symbol.

In yet another aspect of the present disclosure a method for transmitting a PDCCH Orthogonal time frequency-division multiplexing (OTFDM) symbol is provided. The method comprising time-multiplexing, by the transmitter, a physical downlink control channel (PDCCH) sequence and a reference sequence (RS) to generate a multiplexed sequence; and processing, by the transmitter, the multiplexed sequence to generate a PDCCH OTFDM symbol.

In yet another aspect of the present disclosure a method for transmitting a PDCCH-PDSCH Orthogonal time frequency-division multiplexing (OTFDM) slot is provided. The method comprising time-multiplexing, by the transmitter, a PDCCH-PDSCH OTFDM symbol and a plurality of PDSCH OTFDM symbols to generate a PDCCH-PDSCH Orthogonal time frequency-division multiplexing (OTFDM) slot.

In yet another aspect of the present disclosure a method for transmitting a PDCCH-PDSCH Orthogonal time frequency-division multiplexing (OTFDM) slot is provided. The method comprising time-multiplexing, by the transmitter, a PDCCH OTFDM symbol, a plurality of PDSCH OTFDM symbols to generate a PDCCH-PDSCH Orthogonal time frequency-division multiplexing (OTFDM) slot.

In yet another aspect of the present disclosure method for transmitting a downlink frame is provided. The method comprising time-multiplexing, by the transmitter, at least one SS Block and at least PDCCH-PDSCH OTFDM slot to generate at least one downlink signal associated with a beam.

In yet another aspect of the present disclosure a method for transmitting a downlink frame is provided. The method comprising time-multiplexing, by the transmitter, a plurality of SS Blocks associated with a plurality of beams and a plurality of PDCCH-PDSCH OTFDM symbols associated with a plurality of beam to generate a downlink frame.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A shows a block diagram of an OTFDM transmitter, in accordance with an exemplary embodiment of the present disclosure;

FIG. 1B shows a block diagram of an OTFDM symbol generating unit, in accordance with an embodiment of the present disclosure;

FIG. 1C shows a block diagram of a processing unit of the OTFDM symbol generating unit as shown in FIG. 1B, in accordance with an exemplary embodiment of the present disclosure;

FIG. 2A shows an illustration of PSS, SSS, PBCH carried in one OTFDM SSB symbol, in accordance with an embodiment of the present disclosure;

FIG. 2B shows an illustration of different OTFDM Symbol carrying SSB;

FIG. 2C shows an example illustration of a pre DFT sequence where PSS base sequence is repeated N times to generate an OTFDM symbol in time;

FIG. 2D shows an example illustration of a pre DFT sequence where SSS base sequence is repeated N times to generate an OTFDM symbol in time;

FIG. 3A shows an illustration of multiple SS block OTFDM symbols in a frame;

FIG. 3B shows an illustration of multiple SS block OTFDM symbols in a slot associated with different beams;

FIG. 3C shows a beam sweeping over successive OTFDM symbols, in a downlink transmitter; and

FIG. 3D shows a beam sweeping in a single OTFDM symbol, in a downlink transmitter;

FIG. 3E shows an illustration of generation of an OTFDM symbol where two SS blocks are time multiplexed and each SS block is associated with a different beam;

FIG. 4A shows an illustration of generation of PSS OTFDM symbol, SSS OTFDM symbol and PBCH OTFDM symbol;

FIG. 4B shows an illustration of an SS block consisting of 3 OTFDM symbols in time;

FIG. 4C shows an illustration of SS block consisting of 2 OTFDM symbols in time;

FIG. 4D shows an illustration of multiple SS blocks transmission within a frame, where each SS block consists of 3 OTFDM symbols (PSS OTFDM, SSS OTFDM, PBCH OTFDM);

FIG. 5A shows a block diagram of an OTFDM transmitter, in accordance with another embodiment of the present disclosure;

FIG. 5B shows an illustration of different OTFDM Symbol carrying downlink channels;

FIG. 6 shows the generation of a single OTFDM symbol;

FIG. 7 shows allocation of SS block, PDCCH and PDSCH OTFDM symbols in a slot with their associated beam, where a slot has N symbols;

FIG. 8 shows allocation of SS block, PDCCH and PDSCH OTFDM symbols in a frame with their associated beam, where a slot consisting of 1 OTFDM symbol; and

FIG. 9 illustrates the sequence of messages exchanged between a UE and a gNB till RRC connection is established.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The present disclosure provides a waveform technology that not only addresses this critical issue of improving energy efficiency but also achieves one of the major goals of future wireless communication systems i.e., extremely low latency. Current 5G standards uses slot structure, where user data is transmitted in series of OFDM symbols. A typical slot structure comprises of one or more data symbols and one or more reference symbols.

Embodiments of the present disclosure provides a new waveform which allows synchronization channels such as PSS, SSS and PBCH and control channels PDCCH, data channel PDSCH to be transmitted with low PAPR, high PA efficiency, low latency using multiple antenna ports or beams. The embodiments illustrate how low latency is obtained from entire system operation point of view.

Embodiments of the present disclosure provides a new type of waveform that allows time division multiplexing of data/control and RS within a single OFDM symbol (TDM within a OFDM Symbol). The generated symbol is referred to as orthogonal time frequency division multiplexing (OTFDM) symbol, which is designed for information exchange taking place in one shot transmission. The duration of the OFDM symbol (or subcarrier width) is to meet the overall latency requirement.

In a downlink (DL) transmission, a communication system or transmitter uses a method of TDM of user data/control/RS and also common channels such as PSS, SSS, PBCH using OTFDM waveform. However, multiple services and multiple numerologies can be frequency multiplexed using FDM based on the BWP concept that uses WOLA/filtering for frequency multiplexing of these services.

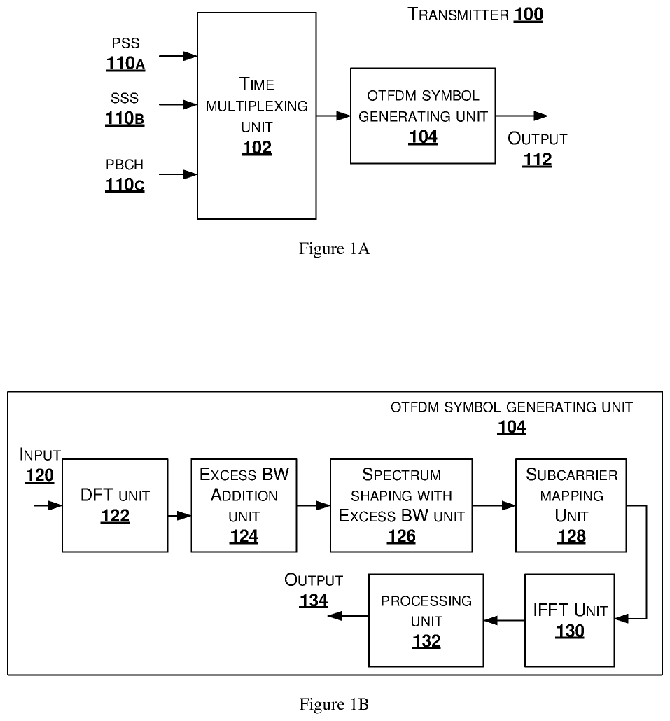

FIG. 1A shows a block diagram of an OTFDM transmitter, in accordance with an exemplary embodiment of the present disclosure. The OTFDM transmitter is referred to as a transmitter or a communication system.

As shown in the FIG. 1A, the transmitter 100 comprises a time multiplexing unit 102 and an OTFDM symbol generating unit 104. The time multiplexing unit 102 is also referred as a time multiplexer or multiplexer or time division multiplexer or TDM. Also, the transmitter 100 comprises a plurality of antennas. The OTFDM symbol generating unit 104 is also referred as OTFDM symbol generator or symbol generator.

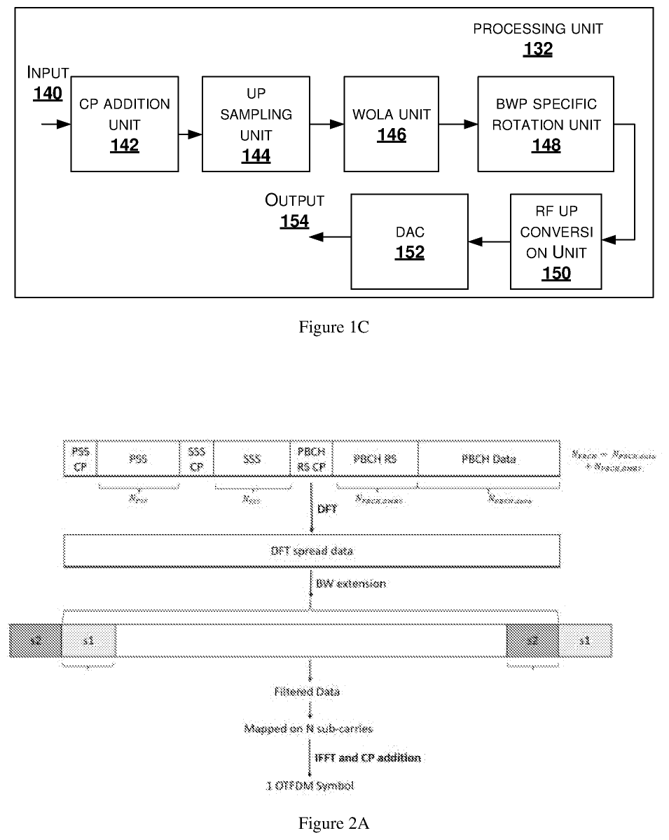

In an embodiment, the time multiplexer 102 multiplexes a PSS sequence 110A, an SSS sequence 110B, and a PBCH sequence 110C to generate a multiplexed sequence. The multiplexed sequence is also referred to as time multiplexed sequence or TDM sequence or pre-DFT symbols. The symbols shown in FIG. 2B are the multiplexed sequences obtained using time multiplexer 102.

The OTFDM symbol generating unit 104 generates an output 134 called as OTFDM symbol using the multiplexed sequences. As the multiplexed sequence is obtained using the PSS sequence, the SSS sequence and PBCH sequence, the generated symbol is referred as synchronization signal (SS) Block Orthogonal time frequency-division multiplexing (OTFDM) symbol or SS Block OTFDM symbol.

In an embodiment, the multiplexed sequence is fed to the OTFDM symbol generating unit 104, to generate a OTFDM symbols specific to a particular antenna. The symbol generated is transmitted by one of a specific antenna from the plurality of antennas.

FIG. 1B shows a block diagram of an OTFDM symbol generating unit, in accordance with an embodiment of the present disclosure. As shown in the FIG. 1B, the OTFDM symbol generating unit 104 comprises a Discrete Fourier Transform (DFT) unit 122, an excess BW addition unit 124, a spectrum shaping with excess BW unit 126, a sub-carrier mapping unit 128, an inverse Fast Fourier transform (FFT) unit 130 and a processing unit 132.

The DFT unit 122 transforms an input 120 i.e. multiplexed sequence using a Discrete Fourier Transform (DFT) to generate a transformed multiplexed sequence.

The excess BW addition unit 124 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping with excess BW unit 126, also referred as a shaping unit or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 128, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The IFFT unit 130 performs inverse IFFT on the shaped extended bandwidth transformed multiplexed sequence to produce a time domain sequence. The time domain sequence is processed by the processing unit 132 to generate an OTFDM symbol.

FIG. 1C shows a block diagram of a processing unit of the OTFDM symbol generating unit as shown in FIG. 1B, in accordance with an exemplary embodiment of the present disclosure. As shown in FIG. 1C, the processing unit 132 comprises a cyclic prefix (CP) addition unit 142, an up sampling unit 144, a weighted with overlap and add operation (WOLA) unit 146, a bandwidth parts (BWP) specific rotation unit 148, a RF up-conversion unit 150, and a digital to analog converter (DAC).

The processing unit 132 processes the time domain sequence to generate an OTFDM symbol. The processing comprises performing at least one of a symbol specific phase compensation, an addition of symbol cyclic prefix using the CP addition unit 142, up sampling using the up-sampling unit 144, addition of symbol cyclic suffix, windowing, weighted with overlap and add operation (WOLA) using the WOLA unit 146, bandwidth parts (BWP) rotation using BWP specific rotation unit 148, an additional time domain filtering, sampling rate conversion to match DAC rate, frequency shifting on the time domain waveform using RF up conversion unit 150 and converting the same into analog using the DAC 152, to generate the output OTFDM symbol 154. The generated OTFDM symbol offers low PAPR.

One embodiment of the present disclosure is a method for transmitting synchronization signal (SS) Block Orthogonal time frequency-division multiplexing (OTFDM) symbol. The order in which the method steps is described is not intended to be construed as a limitation, and any number of the described method steps can be combined in any order to implement the method. Additionally, individual method steps may be deleted from the methods without departing from the scope of the subject matter described herein. Furthermore, the method can be implemented in any suitable hardware, software, firmware, or combination thereof.

The method comprising time-multiplexing, by the transmitter, at least one of a primary synchronization signal (PSS) sequence, a secondary synchronization signal (SSS) sequence and a physical broadcast channel (PBCH) sequence to generate a multiplexed sequence. Thereafter, processing is performed on the multiplexed sequence to generate a SS Block OTFDM symbol.

The method of processing the multiplexed sequence to generate the SS Block OTFDM symbol comprising transforming the multiplexed sequence using a Discrete Fourier Transform (DFT) to generate a transformed multiplexed sequence. The method comprises performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero.

Also, the method comprises mapping the extended bandwidth transformed multiplexed sequence with at least one of localized and distributed subcarriers to generate a mapped extended bandwidth transformed multiplexed sequence. A shaping is performed on the mapped extended bandwidth transformed multiplexed sequence using a filter to obtain a shaped extended bandwidth transformed multiplexed sequence.

Further, the method comprises performing an Inverse Fast Fourier Transform (IFFT) on the shaped extended bandwidth transformed multiplexed sequence to produce a time domain sequence. Thereafter, the method comprises processing the time domain sequence to generate the OTFDM symbol. This processing of the time domain sequence to generate a OTFDM symbol comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the OTFDM symbol.

The SS Block OTFDM symbol is one of a PSS OTFDM symbol comprising of only PSS sequence, a SSS OTFDM symbol comprising of only SSS sequence, a PBCH OTFDM symbol comprising of only PBCH sequence, and OTFDM symbol comprising of PSS, SSS, PBCH sequences. In an embodiment, length of the PSS sequence, the SSS sequence and the PBCH sequence are same or different.

The PSS sequence includes one of a PSS cyclic prefix (CP), and a PSS CP along with a PSS cyclic suffix (CS). The SSS sequence includes one of a SSS CP and a SSS CP along with a SSS CS. The PBCH sequence comprises at least one of a PBCH data and a PBCH data CP. In an embodiment, the PSS sequence and SSS sequence may not include CP or CS.

The PSS sequence is one of pi/2 BPSK and ZC. The PSS sequence is a function of sector ID or Base station ID. The PSS sequence is one sequence for all sectors or one of N possible sequences, wherein N is an integer. The PSS sequence comprises a base sequence repeated for a predefined number of times, wherein each of the repeated based sequence is multiplied with an element of a code cover sequence.

The SSS sequence is one of pi/2 BPSK and ZC. A gNB ID or sector ID is a function of the SSS sequence number along and the PSS ID. In an embodiment, the SSS sequence comprises of a base sequence repeated for a predefined number of times, wherein each of the repeated based sequence is multiplied with an element of a code cover sequence. The wherein the predefined number is one of 1, 2, 4 or more.

The PBCH sequence may include a PBCH DMRS. In an embodiment, the PBCH DMRS includes at least one of a PBCH DMRS CP and a PBCH DMRS CS. The PBCH DMRS is one of a pi/2 BPSK, a QPSK, and a ZC sequence. The PBCH data is one of a pi/2 BPSK and a QPSK. In an embodiment, the PBCH sequence comprises one of a PBCH CP and a PBCH CP along with PBCH CS.

In another embodiment of the present disclosure, a method for transmitting SS block is provided. The method comprises time-multiplexing, by the transmitter, a PSS OTFDM symbol, a SSS OTFDM symbol and a PBCH OTFDM symbol to generate a multiplexed sequence. Also, the method comprises processing the at least one multiplexed sequence to generate a SS Block. The processing of the at least one multiplexed sequence is performed by the OTFDM generating unit 104 as described and shown in FIG. 1B.

In another embodiment of the present disclosure, a method transmitting OTFDM SS burst is disclosed. The method comprising time-multiplexing a plurality of OTFDM SS Blocks to generate multiplexed OTFDM SS blocks, wherein each of the plurality of OTFDM SS Blocks is associated with a different beam. The multiplexed OTFDM SS blocks are processed by the OTFDM generating unit 104, as described and shown in FIG. 1B, to generate a plurality of OTFDM SS blocks or OTFDM SS Burst. The OTFDM SS burst is transmitted through a predefined number of beams, wherein the multiplexed SS blocks are transmitted in succession one for each beam, said predefined number is one of 1, 8, 16, 32, 64, and 128. The method for transmitting a plurality of OTFDM SS bursts is performed such that two successive OTFDM SS Bursts are time separated by a half frame.

In another embodiment of the present disclosure, a method for transmitting an OTFDM SS burst is provided. The method comprising time-multiplexing a plurality of pre-DFT SS Blocks and guard blocks to generate a time multiplexed block, wherein each of the plurality of pre-DFT SS Blocks comprises a PSS, a SSS and a PBCH, said each of the plurality of pre-DFT SS block is associated with a beam. Each of the guard blocks is a sequence. Thereafter, processing the multiplexed block using OTFDM generation unit to generate OTFDM SS burst. The processing of the at least one multiplexed sequence is performed by the OTFDM generating unit 104 as described and shown in FIG. 1B.

FIG. 2A shows an illustration of PSS, SSS, PBCH carried in one OTFDM SSB symbol, in accordance with an embodiment of the present disclosure.

FIG. 2A is showing different steps involved in the generation of the above explained time multiplexed filtered-extended bandwidth single symbol. In the steps shown CP is added to PSS, SSS and PBCH. As part of CP and CS addition, after DFT spreading of the data, the bandwidth of the signal is extended and this extended bandwidth signal is used for OTFDM generation by passing it through the IFFT and CP addition modules.

FIG. 2B shows an illustration of different OTFDM Symbol carrying SSB, in accordance with an embodiment of the present disclosure. FIG. 2C shows an example illustration of a pre DFT sequence where PSS base sequence is repeated N times to generate an OTFDM symbol in time. FIG. 2D shows an example illustration of a pre DFT sequence where SSS base sequence is repeated N times to generate an OTFDM symbol in time.

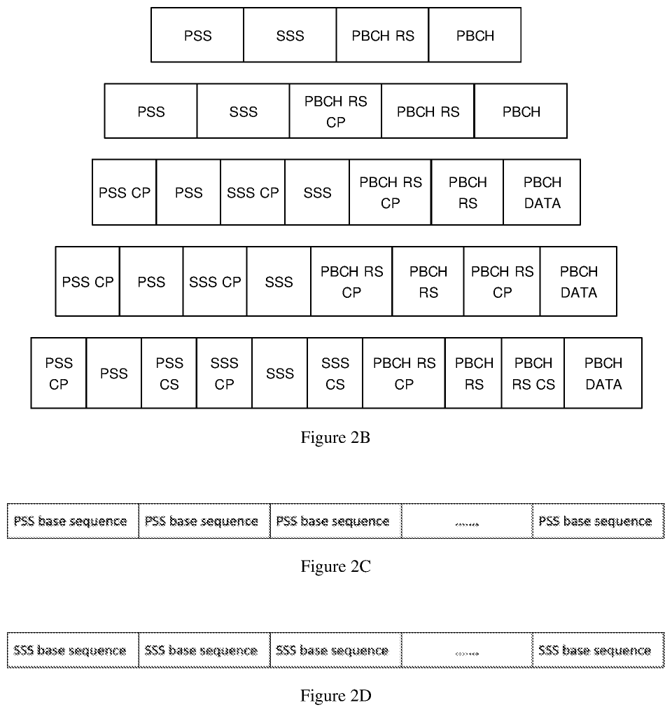

FIG. 3A shows an illustration of multiple SS block OTFDM symbols in a slot. The pattern of SS block OTFDM symbol positions in time within a half frame repeats itself with a periodicity of a half frame.

The FIG. 3A illustrates the transmission of SS burst, where multiple OTFDM SS block symbols are transmitted in a half frame. Different SS blocks associated with different beams are occupying different symbols in a slot. A maximum of Lmax SS blocks are transmitted in a half frame, where Lmax defines the maximum number of the beams having unique beam IDs. The periodicity of the SS burst transmission can be a half frame, a frame, two frames etc. In the example figure, it is showing the periodicity of SS burst transmission as a half frame. The candidate OTFDM SS block symbols in a half frame are indexed in an ascending order in time from 0 to Lmax−1. In the FIG. 3A, 2n slots are there in a frame. The slots in the frame are numbered from 0 to 2n−1 in ascending order in time.

FIG. 3B shows an illustration of multiple SS block OTFDM symbols in a slot associated with different beams.

As shown in FIG. 3B, the transmission of different OTFDM SS block symbols in time, having different beam IDs, associated with different beams in different directions is provided. To construct a beam in a specific direction, the SS block OTFDM symbol as shown in the FIG. 3B is precoded by multiplying with antenna port weight factors and transmitted over the antenna ports.

One embodiment of the present disclosure is Beam sweeping system. FIG. 3C shows a beam sweeping over successive OFDM symbols, in a downlink transmitter. As shown in FIG. 3C, a beam sweeping is performed over successive OFDM symbols. As shown in FIG. 3C, the synchronization channel structure in the beam sweeping systems where each symbol undergoes transmission in a specific beam. A sync comprising of PSS, SSS, PBCH is transmitted in one symbol dedicated to one beam number. The same RS sequence may be transmitted in successive symbols or the sequence may be function of one or more combinations of: OFDM symbol number, and cell ID or sector ID or beam ID.

FIG. 3D shows a beam sweeping in a single OFDM symbol, in a downlink transmitter. As shown in FIG. 3D, the synchronization channel structure is for beam sweeping systems where a symbol is divided into multiple symbols and each sub-symbol undergoes transmission in a specific beam. A sync comprising of PSS, SSS, PBCH is transmitted in one sub-symbol dedicated to one beam number. The same RS sequence may be transmitted in successive sub-symbols or the sequence may be function of one or more combinations of: OFDM sub-symbol number, and cell ID or sector ID or beam ID.

FIG. 3E shows an illustration of generation of an OTFDM symbol where two SS blocks are time multiplexed and each SS block is associated with a different beam. It illustrates the case where multiple SS blocks are transmitted over the same OTFDM symbol in time. Two pre DFT SS blocks having PSS, SSS and PBCH sequences are placed along with some guard sequence R in between. The thus arranged sequence is then passed through precoder, DFT spread and BW extension and filtering module to generate a filtered bandwidth extended signal. This signal is then subcarrier mapped and IFFT and CP addition is performed on it to generate an OTFDM symbol.

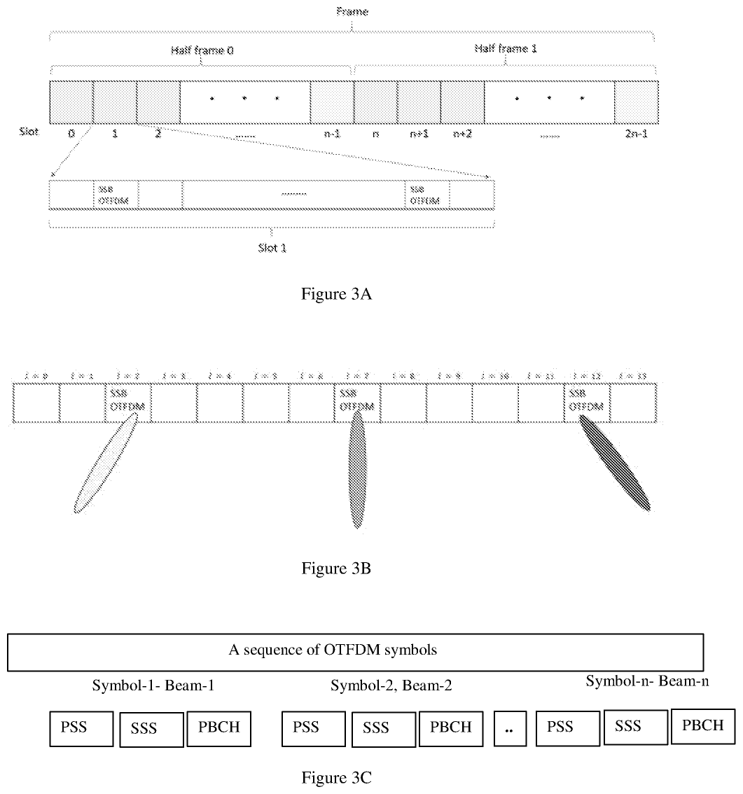

FIG. 4A shown an illustration of generation of PSS OTFDM symbol, SSS OTFDM symbol and PBCH OTFDM symbol. FIG. 4B shows an illustration of an SS block consisting of 3 OTFDM symbols in time. FIG. 4C shows an illustration SS block consisting of 2 OTFDM symbols in time.

FIG. 4D illustrates the transmission of SS burst, where multiple SS blocks are transmitted in a half frame. Each SS block consists of PSS OTFDM, SSS OTFDM and PBCH OTFDM symbol. Different SS blocks associated with different beams are occupying different symbols in a slot. A maximum of Lmax SS blocks are transmitted in a half frame, where Lmax defines the maximum number of the beams having unique beam IDs. In the example figure, the SS burst transmission periodicity is a half frame. The candidate SS blocks in a half frame are indexed in an ascending order in time from 0 to Lmax−1. In the figure, 2n slots are there in a frame. The slots in the frame are numbered from 0 to 2n−1 in ascending order in time.

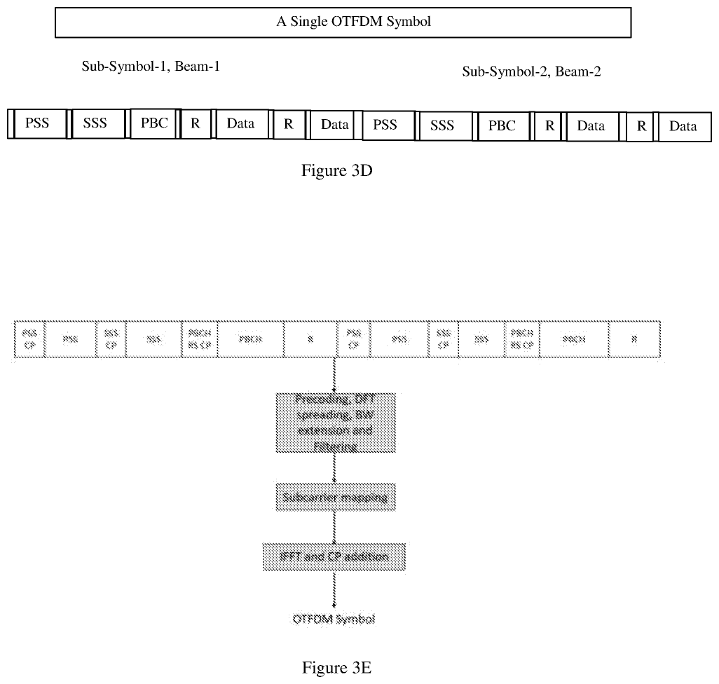

FIG. 5A shows a block diagram of an OTFDM transmitter, in accordance with another embodiment of the present disclosure. The OTFDM transmitter 500 is referred to as a transmitter or a communication system.

As shown in the FIG. 5A, the transmitter 500 comprises a time multiplexing unit 502 and an OTFDM symbol generating unit 104. The time multiplexing unit 502 is also referred as a time multiplexer or multiplexer or time division multiplexer or TDM. Also, the transmitter 500 comprises a plurality of antennas. The OTFDM symbol generating unit 104 is also referred as OTFDM symbol generator or symbol generator which is as shown in FIG. 1B.

In an embodiment, the time multiplexer 502 multiplexes a reference sequence (RS) 510A, a physical downlink control channel (PDCCH) sequence 510B, and a physical downlink shared channel (PDSCH) sequence 510C to generate a multiplexed sequence. The multiplexed sequence is also referred to as time multiplexed sequence or TDM sequence or pre-DFT symbols. The symbols shown in FIG. 5B are the multiplexed sequences obtained using time multiplexer 502.

The OTFDM symbol generating unit 104, which is as shown in FIG. 1B, generates an output 512 called as OTFDM symbol using the multiplexed sequences. As the multiplexed sequence is obtained using the PDCCH sequence, the PDSCH sequence and the RS, the generated symbol is referred as PDCCH-PDSCH Orthogonal time frequency-division multiplexing (OTFDM) symbol or PDCCH-PDSCH OTFDM symbol.

In an embodiment, the multiplexed sequence is fed to the OTFDM symbol generating unit 104, to generate a OTFDM symbols specific to a particular antenna. The symbol generated is transmitted by one of a specific antenna from the plurality of antennas.

In an embodiment, the duration of the PDCCH sequence and the PDSCH sequences is unequal. The PDCCH carries a common control information and a user specific control information. The PDSCH carries a user specific data. The RS is used to demodulate the PDCCH and PDSCH by one or more receiving users. FIG. 5B shows an illustration of different OTFDM Symbol carrying downlink channels.

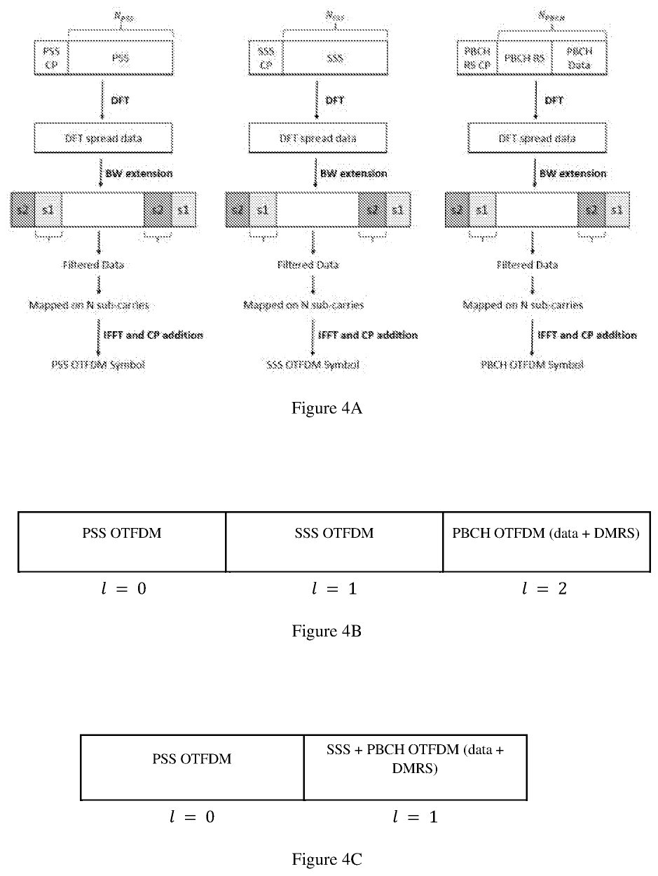

FIG. 6 shows an illustration of generation of DL OTFDM symbols. In the left figure, an OTFDM symbol is generated using only PDCCH data and DL RS. In the figure in center, it describes the generation of an OTFDM symbol where PDCCH and PDSCH are time multiplexed along with DL RS. The figure on the right end is representing how to generate an OTFDM symbol consisting of only of PDSCH and RS.

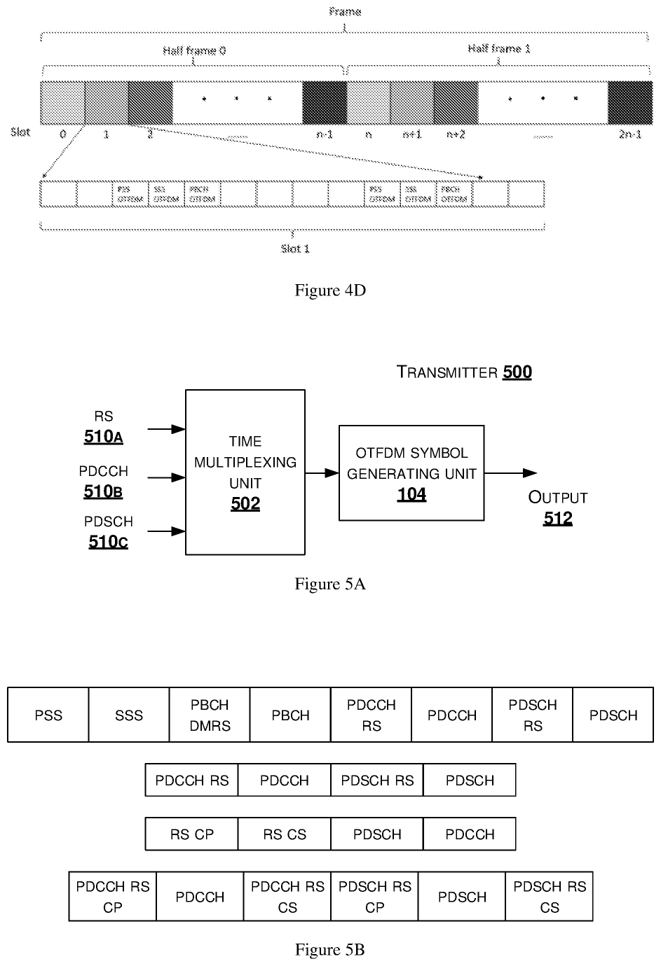

FIG. 7 shows allocation of SS block, PDCCH and PDSCH OTFDM symbols in a slot with their associated beam, where a slot has N symbols. As shown in FIG. 7, multiple DL OTFDM symbols are transmitted in a slot within a frame. Also in FIG. 7, a slot consists of N symbols. Each symbol is associated with a beam thus enabling different beam directions for the DL OTFDM symbols.

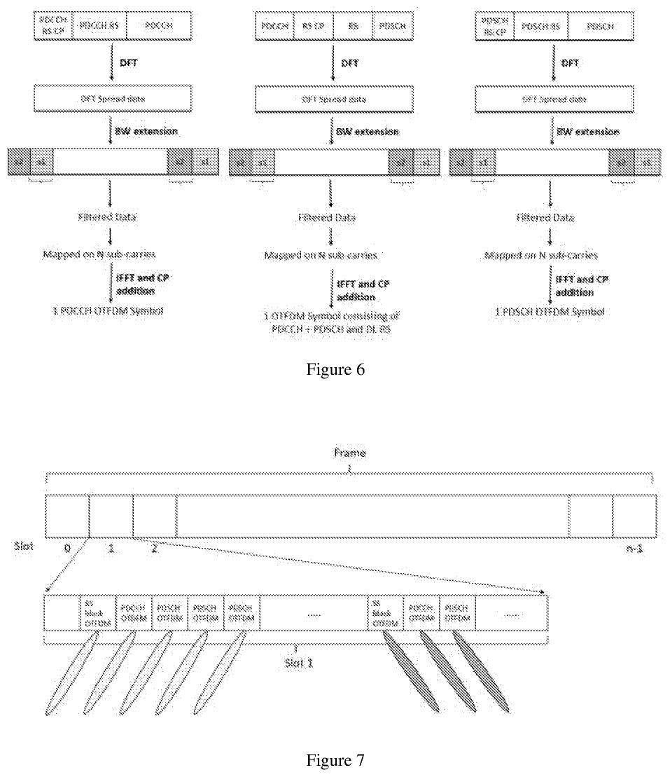

FIG. 8 shows allocation of SS block, PDCCH and PDSCH OTFDM symbols in a frame with their associated beam, where a slot consisting of 1 OTFDM symbol. As shown in FIG. 8, the transmission of DL OTFDM symbols is in one frame. There are n slots in a frame and each slot is consisting of 1 OTFDM symbol. The symbol in each slot is associated with a beam as shown in the FIG. 8.

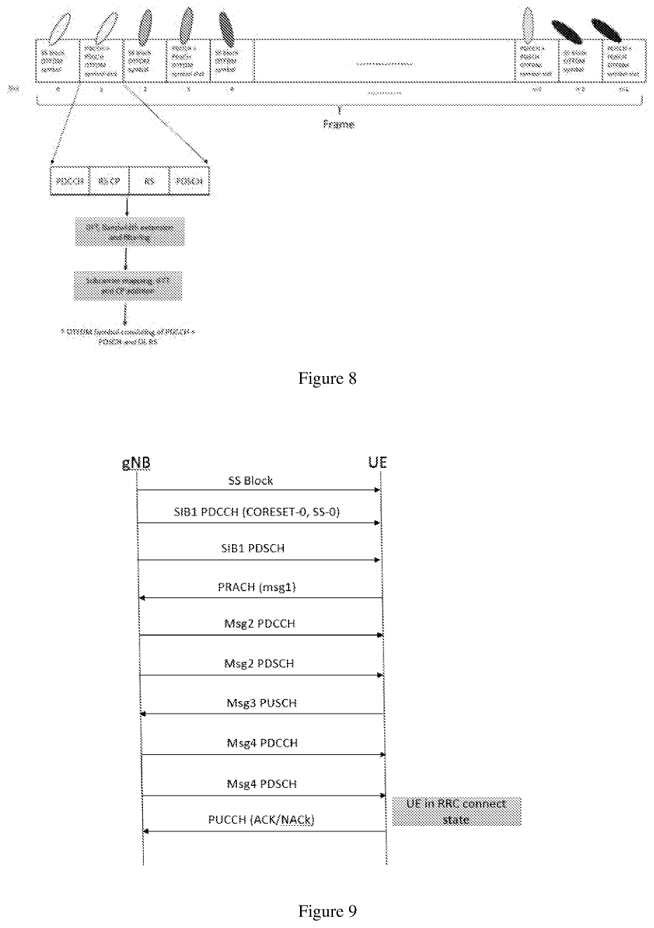

FIG. 9 shows the flow of different messages between a UE and a gNB till RRC connection is established. The UE is referred to as a user. The gNB is a base station or BS. The SS block consists of PSS, SSS and PBCH. PSS and SSS together conveys the gNB ID or the physical Cell ID. PBCH conveys Master Information Block (MIB). MIB contains information such as Control Resource Set 0 (CORESET-0) and Search Space 0 (SS-0) location required to decode PDCCH associated with the (System Information Block-1) SIB1 PDSCH, subcarrier spacing configuration to be used for SIB1, msg2/msg4 for initial access, paging and broadcast SI messages, System Frame Number (SFN) etc. SS blocks associated with different beam IDs are allocated different symbol start locations within a half frame.

The base station transmits these synchronization signal blocks using directional beams. The UE detects one of the SS block beams and the detected beam conveys the symbol location within a half frame to the UE and hence providing the timing information at symbol level granularity. Once MIB is decoded, to get the Remaining Minimum System Information (RMSI) required to access the system, the UE needs to detect the System Information Block-1. The information conveyed by MIB is used to find the CORESET-0 and SS-0 locations which provides the possible location to look for PDCCH. SIB1 PDCCH is scrambled by SI RNTI. The UE blind decoded PDCCH to get Downlink Control information (DCI). The DCI contains information required to decode the corresponding SIB1 PDSCH, such as, time-frequency allocation, Modulation and Coding Scheme, Redundancy version etc. Using this information, a UE decodes SIB1 PDSCH. In SIB1 the gNB transmits the information required by the UE to carry out the initial Random Access Procedure and enables further processing till the RRC attach.

Once the user successfully decodes the SIB-1, it gets to know the time/frequency locations (known as PRACH occasions) where it can perform the initial random access procedure. It picks a preamble-id and performs the random access (or sends message-1) based on the RACH occasions defined in the SIB-1. In the subsequent step, the base station sends the message-2 (or the Random Access Response (RAR)) in the downlink and scrambles the RAR with the random access RNTI (RA-RNTI). This RA-RNTI depends on the PRACH occasions or the time-frequency resources where message-1 has been received. Later on, in message-3 and message-4, the device and the base station exchange messages to resolve the collisions caused due to picking of the same preamble-id by the users. Once the collision is resolved, the user enters the connected state and the communication between the base station and the user can happen using regular dedicated transmissions.

One embodiment of the present disclosure is a method for transmitting a PDCCH-PDSCH Orthogonal time frequency-division multiplexing (OTFDM) symbol. The order in which the method steps is described is not intended to be construed as a limitation, and any number of the described method steps can be combined in any order to implement the method. Additionally, individual method steps may be deleted from the methods without departing from the scope of the subject matter described herein. Furthermore, the method can be implemented in any suitable hardware, software, firmware, or combination thereof.

The method comprising time-multiplexing, by the transmitter, a physical downlink control channel (PDCCH) sequence, a physical downlink shared channel (PDSCH) sequence and a reference sequence (RS) to generate a multiplexed sequence. The method also comprises processing the time multiplexed sequence to generate a PDCCH-PDSCH OTFDM symbol.

The method of processing the multiplexed sequence to generate a PDCCH-PDSCH OTFDM symbol comprising transforming the multiplexed sequence using a Discrete Fourier Transform (DFT) to generate a transformed multiplexed sequence. Also, the method comprises performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. Further the method comprises, mapping the extended bandwidth transformed multiplexed sequence with at least one of localized and distributed subcarriers to generate a mapped extended bandwidth transformed multiplexed sequence, which is shaped using a filter to obtain a shaped extended bandwidth transformed multiplexed sequence. Furthermore, the method comprises performing an Inverse Fast Fourier Transform (IFFT) on the shaped extended bandwidth transformed multiplexed sequence to produce a time domain sequence. The time domain sequence is processed to generate the PDCCH-PDSCH OTFDM symbol.

The processing the time domain sequence to generate a OTFDM symbol comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the PDCCH-PDSCH OTFDM symbol.

The duration of the PDCCH sequence and the PDSCH sequences is unequal. The PDCCH carries a common control information and a user specific control information. The PDSCH carries a user specific data. The RS is used to demodulate the PDCCH and PDSCH by one or more receiving users or user equipment's (UEs).

One embodiment of the present disclosure is a method for transmitting a PDSCH Orthogonal time frequency-division multiplexing (OTFDM) symbol. The method, performed by a transmitter 500, comprising time-multiplexing a physical downlink shared channel (PDSCH) sequence and a reference sequence (RS) to generate a multiplexed sequence and processing the multiplexed sequence to generate a PDSCH OTFDM symbol. The PDSCH carries a user specific data. The RS is used to demodulate the PDSCH by one or more receiving users or user equipment's (UEs).

In another embodiment, a method for transmitting a PDCCH Orthogonal time frequency-division multiplexing (OTFDM) symbol is provided. The method, performed by a transmitter 500, comprises time-multiplexing a physical downlink control channel (PDCCH) sequence and a reference sequence (RS) to generate a multiplexed sequence. Also, the method comprises processing the multiplexed sequence to generate a PDCCH OTFDM symbol. The PDCCH carries a common control information and a user specific control information. The RS is used to demodulate the PDCCH by one or more receiving users or user equipment's (UEs).

One embodiment of the present disclosure is a method for transmitting a PDCCH-PDSCH Orthogonal time frequency-division multiplexing (OTFDM) slot. The method comprising time-multiplexing, by the transmitter 500, a PDCCH-PDSCH OTFDM symbol and a plurality of PDSCH OTFDM symbols to generate a PDCCH-PDSCH Orthogonal time frequency-division multiplexing (OTFDM) slot. The PDCCH-PDSCH slot comprises a control information and a data information intended for one or more receiving users or user equipment's (UEs). The one or more receiving users decode the control information and the data information using the received PDCCH-PDSCH slot.

One embodiment of the present disclosure is a method for transmitting a PDCCH-PDSCH Orthogonal time frequency-division multiplexing (OTFDM) slot. The method comprising time-multiplexing, by the transmitter, a PDCCH OTFDM symbol, a plurality of PDSCH OTFDM symbols to generate a PDCCH-PDSCH Orthogonal time frequency-division multiplexing (OTFDM) slot. The PDCCH-PDSCH slot comprises a control information and a data information intended for one or more receiving users. The one or more receiving UEs or user equipment's (UEs) decode the control information and the data information using the received PDCCH-PDSCH slot.

One embodiment of the present disclosure is a method for transmitting a downlink frame. The method comprises time-multiplexing, by the transmitter, at least one SS Block and at least PDCCH-PDSCH OTFDM slot to generate at least one downlink signal associated with a beam. The users or user equipment's (UEs) associated with the beam decode a SS Block and acquire PSS ID/BS ID, and MIB. Also, the users associated with the beam decode one of corset zero, SIB1, and user data using the received DL signal associated with the beam.

One embodiment of the present disclosure is a method for transmitting a downlink frame. The method comprising time-multiplexing, by the transmitter, a plurality of SS Blocks associated with a plurality of beams and a plurality of PDCCH-PDSCH OTFDM symbols associated with a plurality of beam to generate a downlink frame. The users associated with the beam decode a SS Block and acquire PSS ID/BS ID, and MIB. The users associated with the beam decode one of corset zero, SIB1, and user data using the received DL signal associated with the beam.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting synchronization signal (SS) Block Orthogonal time frequency-division multiplexing (OTFDM) symbol, comprising:
time-multiplexing, by the transmitter, at least one of a primary synchronization signal (PSS) sequence, a secondary synchronization signal (SSS) sequence and a physical broadcast channel (PECH) sequence to generate a multiplexed sequence; and
processing, by the transmitter, the multiplexed sequence to generate a SS Block OTFDM symbol.

2. The method as claimed in claim 1, wherein the SS Block OTFDM symbol is one of a PSS OTFDM symbol comprising of only PSS sequence, a SSS OTFDM symbol comprising of only SSS sequence, a PECH OTFDM symbol comprising of only PECH sequence; and OTFDM symbol comprising of the PSS sequence, the SSS sequence and the PECH Sequence.

3. The method as claimed in claim 1, wherein length of the PSS sequence, the SSS sequence and the PECH sequence are same or different.

4. The method as claimed in claim 1, wherein the PSS sequence includes one of a PSS cyclic prefix (CP), and a PSS CP along with a PSS cyclic suffix (CS).

5. The method as claimed in claim 1, wherein the SSS sequence includes one of a SSS CP and a SSS CP along with a SSS CS.

6. The method as claimed in claim 1, wherein the PECH sequence comprises at least one of a PECH data and a PECH data CP.

7. The method as claimed in claim 1, wherein the PECH sequence includes a PECH DMRS.

8. The method as claimed in claim 1, wherein the PECH DMRS includes at least one of a PECH DMRS CP and a PECH DMRS CS.

9. The method as claimed in claim 1, wherein the PECH DMRS is one of a pi/2 BPSK, a QPSK, and a ZC.

10. The method as claimed in claim 1, wherein the PECH data is one of a pi/2 BPSK and a QPSK.

11. The method as claimed in claim 1, wherein the PECH sequence comprises one of a PECH CP and a PECH CP along with PECH CS.

12. The method as claimed in claim 1, wherein the PSS sequence provides sector id or Base station id.

13. The method as claimed in claim 1, wherein the PSS sequence is one sequence for all sectors or one of N possible sequences, wherein N is an integer.

14. The method as claimed in claim 1, wherein the PSS sequence is one of pi/2 BPSK and ZC.

15. The method as claimed in claim 1, wherein the SSS sequence is one of pi/2 BPSK and ZC.

16. The method as claimed in claim 1, wherein gNB ID or sector ID is a function of the SSS sequence number along and the PSS ID

17. The method as claimed in claim 1, wherein the PSS sequence comprises a base sequence repeated for a predefined number of times, wherein each of the repeated based sequence is multiplied with an element of a code cover sequence.

18. The method as claimed in claim 1, wherein the SSS sequence comprises of a base sequence repeated for a predefined number of times, wherein each of the repeated based sequence is multiplied with an element of a code cover sequence.

19. The method as claimed in claims 17, wherein the predefined number is one of 1, 2, 4 or more.

20. The method as claimed in claim 1, wherein generating the OTFDM symbol by processing the multiplexed sequence comprising:
transforming the multiplexed sequence using a Discrete Fourier Transform (DFT) to generate a transformed multiplexed sequence;
performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence;
mapping the extended bandwidth transformed multiplexed sequence with at least one of localized and distributed subcarriers to generate a mapped extended bandwidth transformed multiplexed sequence;
shaping the mapped extended bandwidth transformed multiplexed sequence using a filter to obtain a shaped extended bandwidth transformed multiplexed sequence;
performing an Inverse Fast Fourier Transform (IFFT) on the shaped extended bandwidth transformed multiplexed sequence to produce a time domain sequence; and
processing the time domain sequence to generate the OTFDM symbol.

21-56. (canceled)
